(19) United States
(12) Patent Application Publication
(10) Pub. No.: US 2025/0053980 A1
(43) Pub. Date: Feb. 13, 2025

(54) BIOMETRIC PAYMENT PROCESSING METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Jun WANG, Shenzhen (CN); Jinkun HOU, Shenzhen (CN); Runzeng GUO, Shenzhen (CN); Shaoming WANG, Shenzhen (CN); Hang ZHOU, Shenzhen (CN); Xiaojie CHEN, Shenzhen (CN)

(21) Appl. No.: 18/928,142

(22) Filed: Oct. 27, 2024

Related U.S. Application Data
(63) Continuation of application No. PCT/CN2023/122099, filed on Sep. 27, 2023.

(30) Foreign Application Priority Data
Nov. 2, 2022 (CN) 202211362513.8

(51) Int. Cl. G06Q 20/40; G06V 10/774; G06V 10/82; G06V 40/10

(52) U.S. Cl. CPC G06Q 20/40145; G06Q 20/407; G06V 10/774; G06V 10/82; G06V 40/10; G06V 2201/07

(57) ABSTRACT

A biometric payment processing method includes: obtaining image data, the image data comprising a plurality of images of an organism that are successively acquired; detecting a target part in an image in the image data, the target part being a part to which a biometric payment function is bound in the organism; determining, in response to that the target part is detected from the plurality of images, a movement speed corresponding to the target part in the plurality of images; and performing a payment operation based on the target part in response to that the movement speed is less than a speed threshold.

### CROSS-REFERENCES TO RELATED APPLICATIONS

This application is a continuation application of PCT Patent Application No. PCT/CN2023/122099, filed on Sep. 27, 2023, which claims priority to Chinese Patent Application No. 202211362513.8 filed on Nov. 2, 2022, the entire contents of both of which are incorporated herein by reference.

### FIELD OF THE TECHNOLOGY

The present disclosure relates to the field of Internet technologies, and in particular, to a biometric payment processing method and apparatus, an electronic device, a computer-readable storage medium, and a computer program product.

### BACKGROUND OF THE DISCLOSURE

With the popularization of the biometric payment technology, an increasing number of users start to use biometric payment (such as face-scan payment or fingerprint payment). According to different payment methods, the biometric payment may be further divided into contact payment and contactless payment. The contact payment is recognition of a trigger signal through contact. For example, there is usually a user tap confirmation operation in such solutions. For a device (for example, a face-scan payment terminal), an interactive screen needs to be provided. In addition, because of the contact payment method, for devices in public places, there may be a problem of device screens being unresponsive or dirty due to public operations.

The contactless payment can resolve the foregoing problems. However, the contactless payment suffers from misrecognition because there is no signal (for example, an electrical signal generated by the contact between a finger and a payment terminal) like that of the contact payment to express a payment intention.

There is need for an effective solution to improve the payment intention recognition for the contactless payment.

### SUMMARY

Embodiments of the present disclosure provide a biometric payment processing method and apparatus, an electronic device, a computer-readable storage medium, and a computer program product, which can improve the accuracy of payment intention recognition for contactless payment, thereby improving the security of payment.

Technical solutions in the embodiments of the present disclosure are implemented as follows:

An embodiment of the present disclosure provides a biometric payment processing method, performed by an electronic device, the method including: obtaining image data, the image data comprising a plurality of images of an organism that are successively acquired; detecting a target part in an image in the image data, the target part being a part to which a biometric payment function is bound in the organism; determining, in response to that the target part is detected from the plurality of images, a movement speed corresponding to the target part in the plurality of images; and performing a payment operation based on the target part in response to the movement speed being less than a speed threshold.

An embodiment of the present disclosure provides a biometric payment processing apparatus, including: an obtaining module, configured to obtain image data, the image data comprising a plurality of images of an organism that are successively acquired; a detection module, configured to detect a target part in an image in the image data, the target part being a part to which a biometric payment function is bound in the organism; a determining module, configured to determine, in response to that the target part is detected from the plurality of images, a movement speed corresponding to the target part in the plurality of images; and a payment module, configured to perform a payment operation based on the target part in response to that the movement speed is less than a speed threshold.

An embodiment of the present disclosure provides an electronic device, including: a memory, configured to store executable instructions; and a processor, configured to execute the executable instructions stored in the memory, to implement the biometric payment processing method provided in the embodiments of the present disclosure.

An embodiment of the present disclosure provides a non-transitory computer-readable storage medium, having a computer-executable instruction stored therein, the computer-executable instruction, when executed by a processor, implementing the biometric payment processing method provided in the embodiments of the present disclosure.

The embodiments of the present disclosure have the following beneficial effects:

Image acquisition is performed on an organism, and when a target part of the organism is detected in a plurality of acquired images, a payment intention is determined according to a movement speed corresponding to the target part in the plurality of images. When it is detected that the movement speed of the target part is less than a speed threshold, that is, the organism has an apparent pausing action, it may be considered that the organism currently has a definite payment intention, and only in this case, a payment operation based on the target part is performed. In this way, the accuracy of payment intention recognition for contactless payment is improved, thereby improving the security of payment.

### BRIEF DESCRIPTION OF THE DRAWINGS

FIG. 1 is a schematic architectural diagram of a biometric payment processing system 100 according to an embodiment of the present disclosure.

FIG. 2 is a schematic structural diagram of an electronic device 500 according to an embodiment of the present disclosure.

FIG. 3 is a schematic flowchart of a biometric payment processing method according to an embodiment of the present disclosure.

FIG. 4 is a schematic flowchart of a biometric payment processing method according to an embodiment of the present disclosure.

FIG. 5 is a schematic flowchart of a biometric payment processing method according to an embodiment of the present disclosure.

FIG. 6 is a schematic diagram of a palm-scan acquisition and payment function model according to an embodiment of the present disclosure.

FIG. 7 is a schematic diagram of an object detection system according to an embodiment of the present disclosure.

FIG. 8 is a schematic diagram of a principle of grid division according to an embodiment of the present disclosure.

FIG. 9 is a schematic structural diagram of a YOLO model according to an embodiment of the present disclosure.

FIG. 10 is a schematic diagram of a position of a palm box of a palm in an image according to an embodiment of the present disclosure.

FIG. 11 is a schematic diagram of a region image of a region in which a palm is located according to an embodiment of the present disclosure.

FIG. 12 is a schematic diagram of palm key points according to an embodiment of the present disclosure.

FIG. 13 is a schematic structural diagram of a key point detection model according to an embodiment of the present disclosure.

FIG. 14 is a schematic diagram of a principle of calling a key point detection model to perform key point detection according to an embodiment of the present disclosure.

FIG. 15 is a schematic diagram of a principle of calculating a movement speed of a palm key point according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but “some embodiments” may be the same subset or different subsets of all the possible embodiments, and can be combined with each other without conflict.

In the embodiments of the present disclosure, relevant data such as user information (for example, a fingerprint and a palm print of a user) is involved. When the embodiments of the present disclosure are applied to specific products or technologies, user permission or consent is required, and collection, use, and processing of the relevant data need to comply with relevant laws, regulations, and standards of relevant countries and regions.

In the following description, the involved terms “first\second\ . . . ” are merely intended to distinguish between similar objects and do not represent a specific order of the objects. “First\second\ . . . ” can be interchanged in a specific order or sequential order if allowed, so that the embodiments of the present disclosure described herein can be implemented in an order other than that illustrated or described herein.

Unless otherwise defined, all technical and scientific terms used in this specification have the same meanings as those usually understood by a person skilled in the technical field of the present disclosure. Terms used in this specification are merely intended to describe objectives of the embodiments of the present disclosure, but are not intended to limit the present disclosure.

Before the embodiments of the present disclosure are further described in detail, a description is made on nouns and terms involved in the embodiments of the present disclosure, and the nouns and terms involved in the embodiments of the present disclosure are applicable to the following explanations.
(1) “In response to” is used for representing a condition or a state on which an operation to be performed depends. When the dependent condition or state is satisfied, one or more operations may be performed in real time or may have a specified delay. Unless otherwise specified, there is no restriction on an order of performing a plurality of operations to be performed.
(2) “Biometric payment” refers to a manner of using a biometric technology to verify a personal identity of a user and authorize payment. The biometric technology is to use physiological features (such as a fingerprint, an iris, and a palm print) and behavioral features (such as handwriting, voice, and gait) inherent in an organism to verify the personal identity by using a computer and technical means such as optical, acoustic, biosensor, and biostatistical principles intimately combined.
(3) “Object detection”, also referred to as target extraction, generally refers to detecting an occurrence position and a corresponding category of an object (for example, a target of interest) in an image.
(4) “Contact payment” is to complete a payment operation through direct contact with a sensor. For example, a user needs to express a payment intention through an electrical signal generated by contact between a finger and a payment terminal. For example, the user needs to tap on a payment confirmation button displayed on a screen of the payment terminal. After receiving a tap operation of the user on the payment confirmation button, the payment terminal performs a subsequent payment operation.
(5) “Contactless payment” is to complete a payment operation without direct contact with a sensor. For example, a feature distinguishable from another biological object, including, for example, a fingerprint feature, a palm feature (including at least a palm print, or may further include an internal structure such as a vein, a bone, or a soft tissue), or a face feature may be recognized from an organism (for example, a human body) without direct contact with the sensor. Verification is performed on identity information of the organism based on the recognized biometric feature, and a subsequent payment operation is performed after the verification succeeds.

The embodiments of the present disclosure provide a biometric payment processing method and apparatus, an electronic device, a computer-readable storage medium, and a computer program product, which can improve the accuracy of payment intention recognition for contactless payment. The following describes exemplary applications of the electronic device provided in the embodiments of the present disclosure. The electronic device provided in the embodiments of the present disclosure may be implemented as a terminal device, or may be implemented as a server, or may be implemented by a terminal device and a server in cooperation.

Description is provided below by using an example in which a server and a terminal device implement in cooperation the biometric payment processing method provided in the embodiments of the present disclosure.

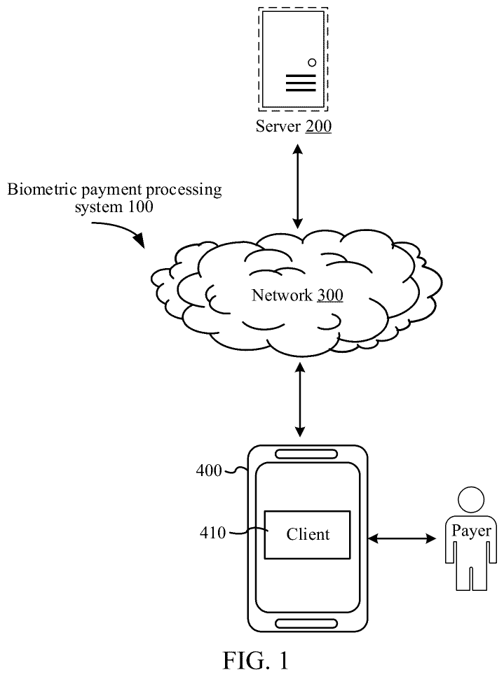

Referring to FIG. 1, FIG. 1 is a schematic architectural diagram of a biometric payment processing system 100 according to an embodiment of the present disclosure. To implement an application supporting an improvement in the accuracy of payment intention recognition for contactless payment, as shown in FIG. 1, the biometric payment processing system 100 includes: a server 200, a network 300, and a terminal device 400. The network 300 may be a local area network or a wide area network, or a combination thereof.

In some embodiments, a client 410 runs on the terminal device 400 (for example, a face-scan payment terminal or a palm-scan payment terminal). The client 410 may be a dedicated payment client, an instant messaging client running in a payment client mode, or the like. The client 410 calls, in response to a biometric feature payment instruction of a payer to make electronic payment, an image sensor built into the terminal device 400 or an external image sensor to perform periodic image acquisition on the payer to obtain image data. Then, the terminal device 400 may send the acquired image data to the server 200 through the network 300. After receiving the image data sent by the terminal device 400, the server 200 may detect a target part (that is, a part to which a biometric payment function is bound of the payer, for example, a palm of the payer) on an image in the image data. When detecting the palm of the payer from a plurality of successively acquired images, the server 200 may further determine a movement speed corresponding to the palm of the payer in the plurality of images. When determining that the movement speed of the palm of the payer is less than a speed threshold (in this case, it may be considered that the payer has a definite payment intention), the server 200 may send a payment notification to the terminal device 400, so that the terminal device 400 performs a payment operation based on the target part. For example, the terminal device 400 may notify a merchant cashier system connected to the terminal device 400 of performing a corresponding deduction operation on an account of the payer.

In some other embodiments, the biometric payment processing method provided in the embodiments of the present disclosure may alternatively be performed by a terminal device separately. The terminal device 400 shown in FIG. 1 is used as an example. After obtaining image data obtained by performing image acquisition on a payer, the terminal device 400 may use an operation capability thereof to perform detection of a target part in an image in the image data, and calculate a movement speed corresponding to the target part in a plurality of images. Subsequently, when determining that the movement speed of the target part is less than a speed threshold, the terminal device 400 may notify a merchant cashier system connected thereto of performing a corresponding deduction operation on an account of the payer.

In some embodiments, the embodiments of the present disclosure may alternatively be implemented by using a cloud technology. The cloud technology refers to a hosting technology that unifies a series of resources such as hardware, software, and networks within a wide area network or a local area network to implement calculation, storage, processing, and sharing of data.

The cloud technology is a general term for a network technology, an information technology, an integration technology, a management platform technology, an application technology, and the like based on an application of a cloud computing business model, may form a resource pool, and may be used as required, which is flexible and convenient. A cloud computing technology is to become an important support. A background service of a technical network system requires a large amount of computing and storage resources.

For example, the server 200 in FIG. 1 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 400 may be a smartphone, a tablet computer, a notebook computer, a desktop computer, a smart speaker, a smartwatch, a face-scan payment terminal, a palm-scan payment terminal, or the like, but is not limited thereto. The terminal device 400 and the server 200 may be directly or indirectly connected in a wired or wireless communication protocol. This is not limited in the embodiments of the present disclosure.

In some other embodiments, the terminal device 400 may alternatively implement the biometric payment processing method provided in the embodiments of the present disclosure by running a computer program. For example, the computer program may be a native program or a software module in an operating system, and may be the client 410 described above. The client may be a native application (APP), that is, a program that needs to be installed in the operating system to run, for example, a payment APP. The client may alternatively be a mini program, that is, a program that only needs to be downloaded into a browser environment to run. The client may alternatively be a payment mini program that can be embedded in any APP. In summary, the foregoing computer program may be any form of application, module, or plug-in.

In some embodiments, the biometric payment processing method provided in the embodiments of the present disclosure may alternatively be implemented in combination with a blockchain technology. A blockchain is a new application mode of computer technologies such as distributed data storage, point-to-point transmission, a consensus mechanism, and an encryption algorithm. The blockchain is essentially a decentralized database and is a string of data blocks generated by using a cryptographic method. Each data block includes information about a batch of network transactions, for verifying the validity of the information thereof (for example, anti-counterfeiting) and generating a next block. The blockchain may include an underlying blockchain platform, a platform product service layer, and an application service layer.

For example, after detecting a target part (for example, a palm) of an organism (for example, a user A) from a plurality of successively acquired images, the terminal device may match a palm print feature of the detected palm with a plurality of authorized palm print features stored in the blockchain, and determine identity information corresponding to a matching authorized palm print feature as identity information of the current organism. In this way, based on a tamper-proof feature of the blockchain, the security of payment can be further improved.

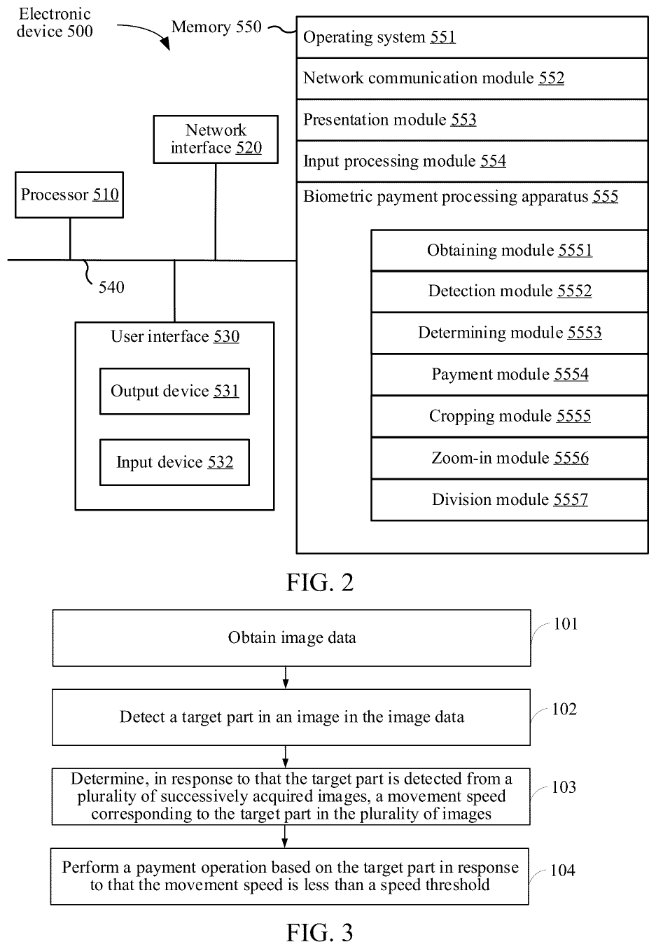

A structure of the electronic device provided in the embodiments of the present disclosure is described below. An example is used in which the electronic device is a terminal device. Referring to FIG. 2, FIG. 2 is a schematic structural diagram of an electronic device 500 according to an embodiment of the present disclosure. The electronic device 500 shown in FIG. 2 includes: at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 also includes a power bus, a control bus, and a status signal bus. However, for clarity of description, all types of buses in FIG. 2 are marked as the bus system 540.

The processor 510 may be an integrated circuit chip and has a signal processing capability, for example, a general purpose processor, a digital signal processor (DSP), or another programmable logical device, a discrete gate or a transistor logical device, or a discrete hardware component. The general purpose processor may be a microprocessor, any processor, or the like.

The user interface 530 includes one or more output devices 531 that enable presentation of media content, including one or more speakers and/or one or more visual display screens. The user interface 530 further includes one or more input devices 532, including a user interface component that facilitates user input, such as a keyboard, a mouse, a microphone, a touchscreen, a camera, and other input buttons and controls.

The memory 550 may be removable, non-removable, or a combination thereof. An exemplary hardware device includes a solid state memory, a hard disk drive, an optical disk drive, or the like. The memory 550 in some embodiments includes one or more storage devices that are physically located away from the processor 510.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in the embodiments of the present disclosure is intended to include any suitable type of memory.

In some embodiments, the memory 550 can store data to support various operations. Examples of the data include programs, modules, and data structures, or subsets or supersets thereof, as exemplarily described below.

An operating system 551 includes system programs for processing various basic system services and performing hardware-related tasks, such as a framework layer, a kernel library layer, and a drive layer, and is configured to implement various basic services and process hardware-based tasks.

A network communication module 552 is configured to reach another computing device through one or more (wired or wireless) network interfaces 520. An example of the network interface 520 includes: Bluetooth, wireless fidelity (WiFi), a universal serial bus (USB), or the like.

A presentation module 553 is configured to enable presentation of information through the one or more output devices 531 (such as display screens or speakers) associated with the user interface 530 (for example, a user interface configured to operate a peripheral device and display content and information).

An input processing module 554 is configured to detect one or more user inputs or interactions from one of the one or more input devices 532 and translate the detected inputs or interactions.

In some embodiments, the apparatus provided in the embodiments of the present disclosure may be implemented in a software manner. FIG. 2 shows a biometric payment processing apparatus 555 stored in the memory 550, which may be software in the form of a program, a plug-in, and the like, and include the following software modules: an obtaining module 5551, a detection module 5552, a determining module 5553, a payment module 5554, a cropping module 5555, a zoom-in module 5556, and a division module 5557. These modules are logical, and therefore may be arbitrarily combined or further split according to an implemented function. In FIG. 2, for convenience of expression, all of the foregoing modules are shown at a time. However, it is not to be considered that an implementation in which the biometric payment processing apparatus 555 may include only the obtaining module 5551, the detection module 5552, the determining module 5553, and the payment module 5554 is excluded. Functions of the modules are to be described below.

The following describes the biometric payment processing method provided in the embodiments of the present disclosure in detail with reference to an exemplary application and implementation of the terminal device provided in the embodiments of the present disclosure.

Referring to FIG. 3, FIG. 3 is a schematic flowchart of a biometric payment processing method according to an embodiment of the present disclosure. Description is to be provided with reference to operations shown in FIG. 3.

The method shown in FIG. 3 may be performed by various forms of computer programs run by the terminal device, not limited to the client, and for example, may alternatively be the operating system, the software module, the script, and the mini program described above. Therefore, the following examples of the client are not to be considered as a limitation on the embodiments of the present disclosure. In addition, for ease of description, the terminal device and the client running on the terminal device are not specifically distinguished in the following.

Operation S101: Obtain image data.

Herein, the image data may be obtained by performing image acquisition on an organism (for example, a human body, that is, a payer, for example, a user A that needs to perform a payment operation).

In some embodiments, when receiving a payment request triggered by the payer, the terminal device (for example, a face-scan payment terminal or a palm-scan payment terminal) may obtain the image data in the following manner: calling an image sensor built into the terminal device or an external image sensor to perform periodic image acquisition on the payer to obtain the image data.

For example, in an example of a palm-scan payment scenario, when the palm-scan payment terminal receives a payment request triggered by the payer, for example, when the palm-scan payment terminal detects, through a distance sensor, that a distance between the payer (for example, the user A) and the palm-scan payment terminal is less than a distance threshold (for example, 20 cm), the palm-scan payment terminal may perform periodic image acquisition on the payer through a built-in image acquisition device (for example, a camera).

For example, in an example of a face-scan payment scenario, the face-scan payment terminal usually may be in a sleep state (for example, a screen of the face-scan payment terminal may be in a screen-off state), to save resources. In addition, when detecting, through a built-in distance sensor, that a distance between a payer (that is, a user that needs to make payment, for example, the user A) and the face-scan payment terminal is less than a distance threshold (for example, 20 cm), the face-scan payment terminal may automatically enter a working state from the sleep state, and call a built-in (or external) image acquisition device (for example, a camera) to perform periodic image acquisition on the user A approaching the face-scan payment terminal.

Operation 102: Detect a target part in an image in the image data.

Herein, the target part refers to a part to which a biometric payment function is bound in the organism. For example, a type of the target part may include: a palm, a finger, a wrist, a face, or the like of the organism.

For example, an example that the target part is a palm of the organism (that is, the payer) is used. Before making palm-scan payment, the payer first needs to perform authentication on the palm. For example, the palm-scan payment terminal first needs to perform image acquisition on the palm of the payer, extract a palm print feature of the payer from the acquired image as a biometric feature authorized by the payer, and store it into a database corresponding to the palm-scan payment terminal for subsequent network verification; or may store the extracted palm print feature of the payer locally in the palm-scan payment terminal for subsequent offline verification.

In some embodiments, the terminal device may detect a target part in an image in the image data in the following manner: calling an object detection model to detect a target part in the image in the image data, the object detection model being obtained through training based on a sample image and a sample part annotated for the sample image.

The object detection model involved in the embodiments of the present disclosure is described below.

In some embodiments, there may be two types of object detection models: a one-stage object detection model (that is, an end-to-end object detection algorithm, for example, including YOLO or SSD) and a two-stage object detection model (that is, an object detection algorithm based on region nomination, for example, including R-CNN, SPP-net, or Fast R-CNN). For the two-stage object detection model, an algorithm first generates a series of bounding boxes as samples, and then a convolutional neural network performs sample classification. The one-stage object detection model does not need to generate a bounding box, but directly transforms the problem of target bounding box positioning into a regression problem for processing. Performance varies with the two different methods. The two-stage object detection model has advantages in detection accuracy and the positioning precision, while the one-stage object detection model has advantages in an algorithm speed.

Description is provided below by using an example in which a two-stage object detection model is called to perform object detection on an image.

For example, the terminal device may call an object detection model to detect a target part in the image in the image data in the following manner: for the image in the image data, calling the object detection model to perform the following processing: determining a plurality of bounding boxes in the image and a confidence score corresponding to each bounding box, the confidence score being configured for representing a probability that the bounding box includes the target part; classifying the each bounding box based on the confidence score according to whether the each bounding box includes the target part; and performing regression processing on a target bounding box determined to include the target part, to obtain a corrected position of the target bounding box.

The following describes a loss function involved in the training process of the object detection model.

In the embodiments of the present disclosure, the object detection model may be trained by using various different types of loss functions, including, for example, a regression loss function, a two-class loss function, a hinge loss, a multi-class loss function, and a multi-class cross-entropy loss.

For example, the multi-class cross-entropy loss is a generalization of a binary cross-entropy loss. For an input vector Xᵢ and a corresponding one-hot encoding target vector Yᵢ, a loss is:

$$L ( {X}_{i} , {Y}_{i} ) = - {\sum }_{j = 1}^{c} {y}_{ij} * log ( {p}_{ij} ) \qquad ( 1 )$$

where pᵢⱼ represents an embedding representation of an encoding feature of a sample image, and yᵢⱼ represents a position of a bounding box annotated on the sample image based on the object detection model.

For example, the hinge loss is mainly used for a support vector machine with a class label (for example, including 1 and 0, where 1 indicates success, that is, the bounding box includes the target part; and 0 indicates failure, that is, the bounding box does not include the target part). For example, a formula for calculating a hinge loss of a data pair (x, y) is as follows:

$$L = max ( 0 , 1 - y * f ( x ) ) \qquad ( 2 )$$

where y represents a sample part annotated for the sample image, and f (x) represents a position of a bounding box annotated on the sample image based on the object detection model and a category of an object included in the bounding box. The hinge loss simplifies a mathematical operation of the support vector machine while maximizing a loss.

In the embodiments of the present disclosure, detection processing of a target part can be performed on an image by calling any one of the foregoing types of object detection models. For example, to improve payment efficiency and reduce a waiting time of a payer, a one-stage object detection model (that is, an end-to-end object detection model) may be called to detect a target part in an image. To improve the accuracy of recognition, a two-stage object detection model may be called to detect a target part in the image. This is not specifically limited in the embodiments of the present disclosure.

In some other embodiments, before detecting the target part in the image in the image data, the terminal device may first perform living body detection processing and quality detection processing on the image in the image data (for example, performing quality score detection processing on the image). When the living body detection processing performed on the image in the image data succeeds and the quality detection processing succeeds, the detection processing of the target part is performed on the image in the image data. In this way, it can be determined whether the image on which the detection is performed originates from a real organism (that is, a living body), thereby avoiding illegal obtaining of identity information by presenting a photograph, a mask, or the like in front of the terminal device, thus improving the security of payment.

Operation 103: Determine, in response to that the target part is detected from the plurality of images, a movement speed corresponding to the target part in the plurality of images.

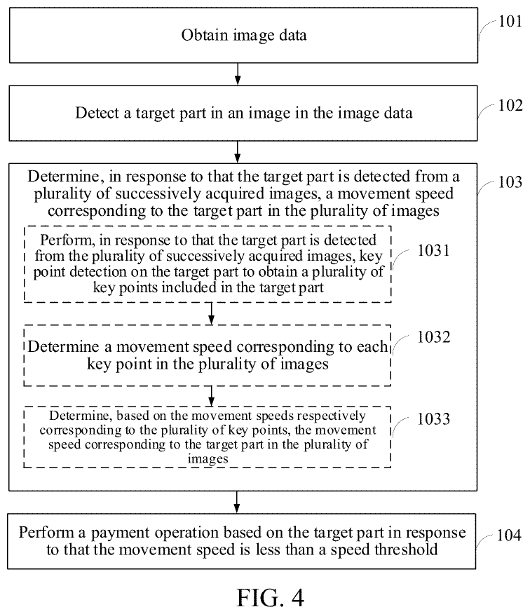

In some embodiments, operation 103 shown in FIG. 3 may be implemented through operation 1031 to operation 1033 shown in FIG. 4. Description is to be provided with reference to operations shown in FIG. 4.

Operation 1031: Perform, in response to that the target part is detected from the plurality of successively acquired images, key point detection processing on the target part to obtain a plurality of key points included in the target part.

In some embodiments, the terminal device may perform key point detection processing on the target part in the following manner: calling a key point detection model to perform key point detection processing on the target part to obtain the plurality of key points included in the target part, the key point detection model being obtained through training based on a sample part of a sample organism and key points annotated for the sample part.

In image processing, a key point is essentially a feature, which is an abstract description of a fixed region or a spatial-physical relationship, and describes a combination or a context relationship within a specific neighborhood. It not only is point information or represents a position, but also represents a combined relationship between a context and a surrounding neighborhood. There are two main methods for key point detection: a method of point regression (such as Coordinate) and a method of point classification (such as Heatmap). Both the methods can find positions and relationships of points in an image. For example, Coordinate is a method that directly uses key point coordinates as an object that a network finally needs to regress. In this case, direct position information of each coordinate point can be directly obtained. Heatmap uses a probability map to represent coordinates of each category. A probability is given to each pixel position in the image, representing a probability that the point is key point of a corresponding category. A probability of a pixel point closer to the key point is closer to 1, and a probability of a pixel point farther from the key point is closer to 0.

For example, using the method of point regression as an example, the key point detection model may include a plurality of cascaded convolutional layers and a plurality of cascaded fully connected layers. In this case, the calling a key point detection model to perform key point detection processing on the target part to obtain the plurality of key points included in the target part may be implemented in the following manner: performing convolution processing on feature information corresponding to the target part through the first convolutional layer in the plurality of cascaded convolutional layers; inputting a convolution result outputted by the first convolutional layer to a subsequent cascaded convolutional layer, and continuing to perform convolution processing through the subsequent cascaded convolutional layer until the last convolutional layer; performing, through the first fully connected layer in the plurality of cascaded fully connected layers, fully connected processing on a convolution result outputted by the last convolutional layer; inputting a fully connected result outputted by the first fully connected layer to a subsequent cascaded fully connected layer, and continuing to perform fully connected processing through the subsequent cascaded fully connected layer until the last fully connected layer; and determining a plurality of points respectively corresponding to a plurality of coordinates outputted by the last fully connected layer in the image as the plurality of key points included in the target part.

For example, that the target part is a palm of the payer is used as an example. In a process of approaching the palm-scan payment terminal by the palm of the payer, due to angular image distortion or other factors, sizes of palm boxes at different distances may be inaccurate, affecting subsequent calculation of a movement speed of the palm. In view of this, in this embodiment of the present disclosure, the key point detection model may be called to perform key point detection processing on a region in which the palm is located in the image to obtain several accurate palm key points that are relatively fixed in the palm, and then the movement speed of the palm is calculated based on the palm key points. This can avoid a problem of a large error in the calculated movement speed resulting from inaccurate sizes of the palm boxes caused by posture interference.

In some other embodiments, before the calling a key point detection model to perform key point detection processing on the target part, the following processing may be further performed: cropping the image to obtain a region image of a region in which the target part is located, zooming in the region image (for example, the region image obtained through cropping may be zoomed in by a set multiple), and then calling the key point detection model to perform key point detection processing on the zoomed-in region image.

For example, an example is used in which the target part is a palm of an organism. To further improve prediction accuracy, before the key point detection model is called to perform key point detection processing on the palm, the image may be first cropped to obtain a region image of a region in which the palm is located, and the region image obtained through cropping is zoomed in by a set multiple. For example, the region image is zoomed in by three times. Then, the zoomed-in region image is input into the key point detection model, so that the positions of the palm key points can be more accurately predicted from the region image.

Operation 1032: Determine a movement speed corresponding to each key point in the plurality of images.

In some embodiments, operation 1032 may be implemented in the following manner: performing the following processing for the each key point: selecting a first image and a second image from the plurality of images, and determining a time difference between an acquisition time of the first image and an acquisition time of the second image; determining a distance between first coordinates and second coordinates, the first coordinates being coordinates of the key point in the first image, and the second coordinates being coordinates of the key point in the second image; and determining a result of dividing the distance by the time difference as the movement speed corresponding to the key point in the plurality of images.

For example, the first image and the second image may be selected from the plurality of images in the following manner: selecting a first image and a second image each with a quality parameter (for example, sharpness, resolution, and an area occupied by the target part in the entire image) greater than a quality parameter threshold from the plurality of images, a time difference between an acquisition time of the first image and an acquisition time of the second image being greater than a time difference threshold (for example, 1 second). For example, the plurality of images may be first sorted in descending order according to quality parameters, and some images with quality parameters greater than the quality parameter threshold are selected from a result of the sorting performed in descending order. Then, an image with the earliest acquisition time in the selected some images may be used as the first image, and an image with the latest acquisition time may be used as the second image. This can avoid a case of an excessively large error in subsequent calculation of the movement speed of the key point caused by an excessively small time difference between the acquisition times of the two images.

Certainly, two images may alternatively be randomly selected from the plurality of selected images with the quality parameters greater than the quality parameter threshold, as the first image and the second image, as long as a time difference between acquisition times of the two images is greater than the time difference threshold. This is not specifically limited in the embodiments of the present disclosure.

For example, an example is used in which the target part is a palm of an organism. When the key point detection model is called to perform key point detection processing on the palm, a plurality of key points included in the palm may be obtained. For example, it is assumed that four key points are included, namely, a key point A, a key point B, a key point C, and a key point D. The key point A may be a finger edge position between a thumb and an index finger. The key point B may be a finger edge position between the index finger and a middle finger. The key point C may be a finger edge position between the middle finger and a ring finger. The key point D may be a finger edge position between the ring finger and a small thumb. After the four key points included in the palm are obtained, a movement speed respectively corresponding to each key point in a plurality of images (for example, it is assumed that there are 10 images: an image 1 to an image 10) may be determined.

Using the key point A of the foregoing four key points as an example, first, the plurality of images may be sorted in descending order according to sharpness, and then some images with sharpness greater than a sharpness threshold (for example, it is assumed that there are four images: an image 2, an image 4, an image 7, and an image 10) are selected from a result of the sorting performed in descending order. In addition, an image with the earliest acquisition time (for example, the image 2) in the selected some images may be used as the first image, and an image with the latest acquisition time (for example, the image 10) may be used as the second image. Subsequently, a time difference between the acquisition time of the image 10 and the acquisition time of the image 2 is calculated, and a distance between coordinates (namely, second coordinates) of the key point A in the image 10 and coordinates (namely, first coordinates) of the key point A in the image 2 is calculated. Finally, a result of dividing the distance by the time difference is determined as a movement speed corresponding to the key point A in the plurality of images.

A manner of calculating movement speeds corresponding to the other key points (namely, the key point B, the key point C, and the key point D described above) in the plurality of images is similar to the manner of calculating the movement speed of the key point A. For the former manner, refer to the manner of calculating the movement speed of the key point A. Details are not described herein again in this embodiment of the present disclosure.

Operation 1033: Determine, based on the movement speeds respectively corresponding to the plurality of key points, the movement speed corresponding to the target part in the plurality of images.

In some embodiments, operation 1033 may be implemented in the following manner: determining an average movement speed of the plurality of movement speeds in a one-to-one correspondence with the plurality of key points; and determining the average movement speed as the movement speed corresponding to the target part in the plurality of images.

For example, an example is used in which the target part is a palm of an organism. It is assumed that after the key point detection model is called to perform key point detection processing on the palm in operation 1031, four key points included in the palm are obtained. It is assumed that the four key points are respectively a key point A, a key point B, a key point C, and a key point D. In addition, it is assumed that movement speeds respectively corresponding to the four key points in the plurality of images calculated through operation 1032 are: V_{A}, V_{B}, V_{C}, and V_{D}. In this case, an average value (that is, an average movement speed) of the four movement speeds may be calculated, as a movement speed corresponding to the palm in the plurality of images. In this way, the accuracy of calculating the movement speed of the palm can be improved.

The terminal device may alternatively first perform verification on identity information of the organism before determining the movement speed corresponding to the target part in the plurality of images. The manner of performing verification on the identity information of the organism includes network verification and offline verification. The network verification means that the terminal device may send an identity recognition request carrying a palm picture to a server after detecting the target part (for example, a palm) from the plurality of images, so that the server extracts a palm print feature from the palm picture sent by the terminal device, and matches the palm print feature with a plurality of authorized palm print features stored in the database, to determine identity information corresponding to the matching authorized palm print feature. The offline verification refers to performing verification locally on the terminal device. For example, after detecting the target part (for example, a palm) from the plurality of images, the terminal device may extract a palm print feature of the palm, match the palm print feature with a plurality of authorized palm print features locally stored in the terminal device, and determine identity information corresponding to the matching authorized palm print feature as the identity information of the current organism.

Operation 104: Perform a payment operation based on the target part in response to that the movement speed is less than a speed threshold.

In some embodiments, when the terminal device detects that the movement speed of the target part of the organism (that is, the payer) is less than a speed threshold, that is, the organism has an apparent pausing action, the terminal device may consider that the payer currently has a definite payment intention, and may perform a payment operation based on the target part, for example, notify a merchant cashier system connected to the terminal device of performing a corresponding deduction operation on an account of the payer.

For example, an example is used in which the target part is a palm of an organism. When the palm-scan payment terminal detects that a movement speed of the palm of the payer is less than a speed threshold, that is, detects that the palm of the payer has an apparent pausing action, it indicates that the payer currently has a definite payment intention. In this case, the palm-scan payment terminal may notify a merchant cashier system connected thereto of performing a deduction operation on an account of the payer. This improves the accuracy of recognizing palm-scan payment is improved, and avoids incorrect deduction caused by simple skimming by the palm of the payer, thereby improving the security of payment.

In some other embodiments, to further improve the accuracy of recognizing contactless payment, the terminal device may further perform the following processing: dividing the plurality of images into a plurality of image groups according to a set frame interval; and determining a movement speed corresponding to the target part in each image group; and performing the payment operation based on the target part in response to that the plurality of movement speeds respectively corresponding to the target part in the plurality of image groups are less than the speed threshold.

For example, an example is used in which the target part is a palm of an organism. To further improve the accuracy of recognizing palm-scan payment, the palm-scan payment terminal may alternatively divide the plurality of images (that is, the plurality of images including the palm) into a plurality of image groups according to a set frame interval (for example, 5 frames), then determine a movement speed corresponding to the palm in each image group, and perform a palm-based payment operation when the movement speed of the palm in the each image group is less than a speed threshold.

In this embodiment of the present disclosure, an amplitude of the frame interval in which the plurality of images are divided may be set according to an actual situation. For example, to save resources of the terminal device, the amplitude of the frame interval may be set to be larger. For example, the frame interval may be set to 10 frames. However, to further improve the accuracy of calculating the movement speed of the target part, the amplitude of the frame interval may be set to be smaller. For example, the frame interval may be set to 5 frames. This is not specifically limited in this embodiment of the present disclosure.

In some embodiments, based on the foregoing example, when detecting that the movement speed of the target part in any one of the image groups is greater than the speed threshold, the terminal device may cancel the payment operation based on the target part. For example, an example is used in which the target part is a palm of an organism. When detecting that the movement speed of the palm of the payer in any one of the image groups is greater than the speed threshold, the palm-scan payment terminal may consider that the payer may simply have the palm skimming over the palm-scan payment terminal rather than actually intending to perform palm-scan payment. In this case, the palm-based payment operation may be canceled to avoid incorrect deduction, thereby improving the security of payment.

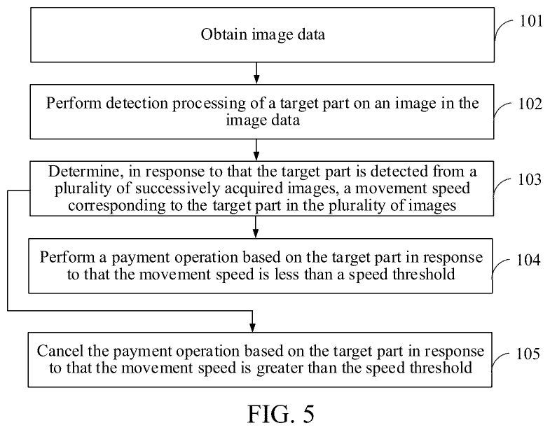

In some other embodiments, referring to FIG. 5, FIG. 5 is a schematic flowchart of a biometric payment processing method according to an embodiment of the present disclosure. As shown in FIG. 5, after operation 103 shown in FIG. 3 is performed, operation 105 shown in FIG. 5 may be further performed. Description is to be provided with reference to operation 105 shown in FIG. 5.

Operation 105: Cancel the payment operation based on the target part in response to that the movement speed is greater than the speed threshold.

In some embodiments, when detecting that the movement speed of the target part is greater than the speed threshold, the terminal device may consider that the organism (that is, the payer) currently has no definite payment intention, and that the payer may simply have the target part skimming over the terminal device. In this case, the payment operation based on the target part may be canceled to avoid incorrect deduction, thereby ensuring the security of payment.

According to the biometric payment processing method provided in the embodiments of the present disclosure, image acquisition is performed on an organism, and when a target part of the organism is detected in a plurality of acquired images, a payment intention is determined according to a movement speed corresponding to the target part in the plurality of images. When it is detected that the movement speed of the target part is less than a speed threshold, it may be considered that the organism has a definite payment intention, and only in this case, a payment operation based on the target part is performed. This improves the accuracy of payment intention recognition for contactless payment, thereby improving the security of payment.

An exemplary application of the embodiments of the present disclosure in an actual application scenario is described below by using palm-scan paying as an example.

In the related technology, confirmation of a payment intention is usually performed by a user clicking/tapping on a confirm payment button. However, in this type of solution, an interactive screen for the payment device needs to be provided because the user needs to click/tap to confirm the operation. In addition, in the presence of contact, for payment devices in public places, there is a problem of device screens being unresponsive or dirty due to public operations.

In view of this, an embodiment of the present disclosure provides a biometric payment processing method. A movement speed of a palm key point of a user in an XY plane is estimated through detection of the palm key point, and a palm movement pause point is determined by determining a speed change curve, to confirm a payment intention of the user. In other words, in the solution provided in this embodiment of the present disclosure, to avoid incorrect deduction, a payment intention of a user needs to be confirmed during a payment process, to ensure that the palm of the user shows a relatively definite and conscious stay during the payment process of the user, thereby avoiding recognition and payment caused by casual skimming by the palm of the user.

The biometric payment processing method provided in the embodiments of the present disclosure is described in detail below.

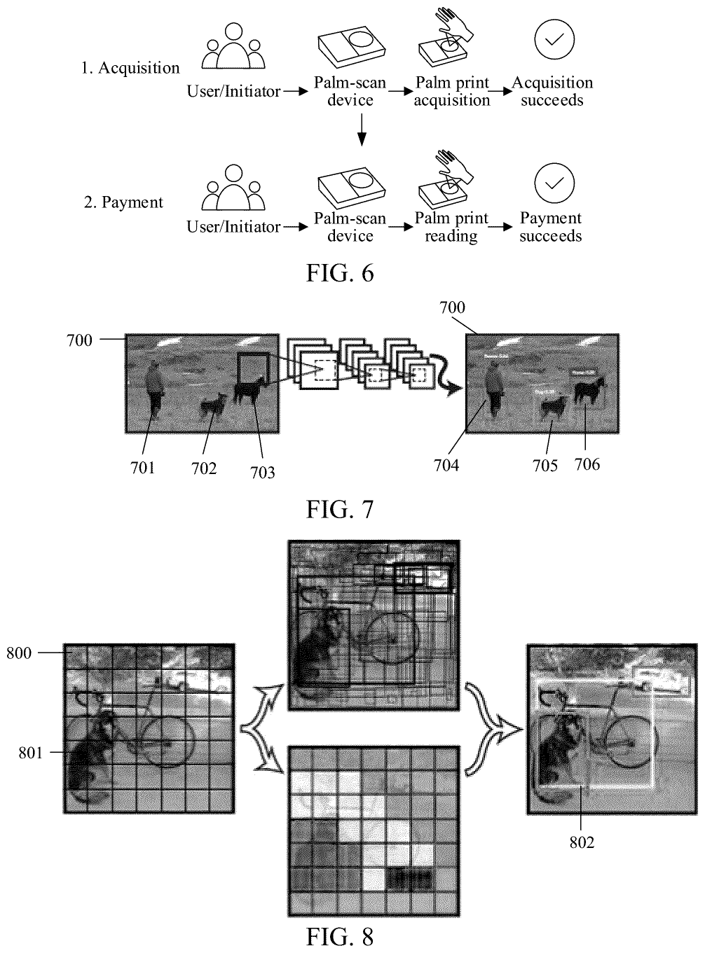

For example, referring to FIG. 6, FIG. 6 is a schematic diagram of a palm-scan acquisition and payment function model according to an embodiment of the present disclosure. As shown in FIG. 6, the palm-scan payment processing method provided in this embodiment of the present disclosure includes two stages of acquisition and payment. At the acquisition stage, a user reaches for palm acquisition, and a palm-scan payment device (namely, a palm-scan device, referred to as a palm-scan device for short below) stores an acquired palm print into a database to be used as an authorized biometric feature of the user. At the payment stage, after reading a palm print of the user, the palm-scan device matches the read palm print with the palm print stored in the database. When the two are consistent, it indicates that verification of identity information of the user succeeds, and then a subsequent payment operation may be performed. In addition, it can also be seen from FIG. 6 that the user reaches for palm acquisition, optimization, and then liveness recognition. The user does not need to perform any contact operation during the entire process.

According to the biometric payment processing method provided in this embodiment of the present disclosure, a movement speed of a palm of a user is estimated by detecting a position of the palm of the user and a more accurate change in a position of a palm key point. When the movement speed of the palm of the user is less than a set speed threshold for a continuous period of time, it may be considered that the user has a definite payment intention and it is not simply skimming interference from the palm. In this way, contactless confirmation of the payment intention of the user is achieved.

In some embodiments, the biometric payment processing method provided in the embodiments of the present disclosure may mainly include the following three operations: 1. palm detection; 2. palm key point detection; and 3. calculation of a palm movement speed. Specific descriptions are provided separately below:

### 1. Palm Detection

In some embodiments, the position of the palm may be detected by using an object detection system shown in FIG. 7, for example, a detection system based on a YOLO model. At a training stage of the YOLO model, sample data with position information of a palm box may be obtained through pre-calibration, and fed into a to-be-trained YOLO model for training, to obtain a trained YOLO model. Subsequently, the palm-scan terminal may perform real-time inference through the trained YOLO model, and finally obtain a palm detection box in the image.

For example, as shown in FIG. 7, after the YOLO model is called to perform object detection processing on an image 700, a bounding box 704 surrounding an object 701 (for example, a human body) and a confidence score corresponding to the bounding box 704, a bounding box 705 surrounding an object 702 (for example, a small dog) and a confidence score corresponding to the bounding box 705, and a bounding box 706 surrounding an object 703 (for example, a big dog) and a confidence score corresponding to the bounding box 706 may be annotated in the image 700.

The YOLO model provided in the embodiments of the present disclosure is described below.

In some embodiments, as shown in FIG. 7, the YOLO model first divides an inputted image into S*S lattices, and then predicts B bounding boxes (also referred to as enclosure boxes) for each lattice. Each bounding box includes five predicted values: x, y, w, h, and confidence. x and y are center coordinates of the bounding box, and are aligned with a grid cell (that is, offset values relative to a current grid cell), so that a range becomes 0 to 1. w and h are a width and a height of the bounding box, respectively, and w and h may be normalized, for example, divided by a width and a height of the image, respectively, so that w and h finally are also in a range of 0 to 1. In addition, as shown in FIG. 8, probabilities of C assumed classes may be predicted for each lattice. For example, when S=7, B=2, and C=20 (that is, it is assumed that there are 20 categories), there may finally be 7*7*30 tensors.

For example, as shown in FIG. 8, to detect whether an object 801 (for example, a small dog) exists in an image 800, the image 800 may be first divided into 49 lattices, a probability that each lattice includes the object 801 is then predicted, and finally, regression processing is performed, to obtain a bounding box 802 that finally includes the object 801.

In addition, each bounding box corresponds to a confidence score. If there is no object in the grid cell, the corresponding confidence score is 0. If there is an object in the grid cell, the corresponding confidence score may be equal to a value of a ratio of intersection over union (IOU) between a predicted box and ground truth (that is, a real box).

A structure of the YOLO model provided in the embodiments of the present disclosure is described below.

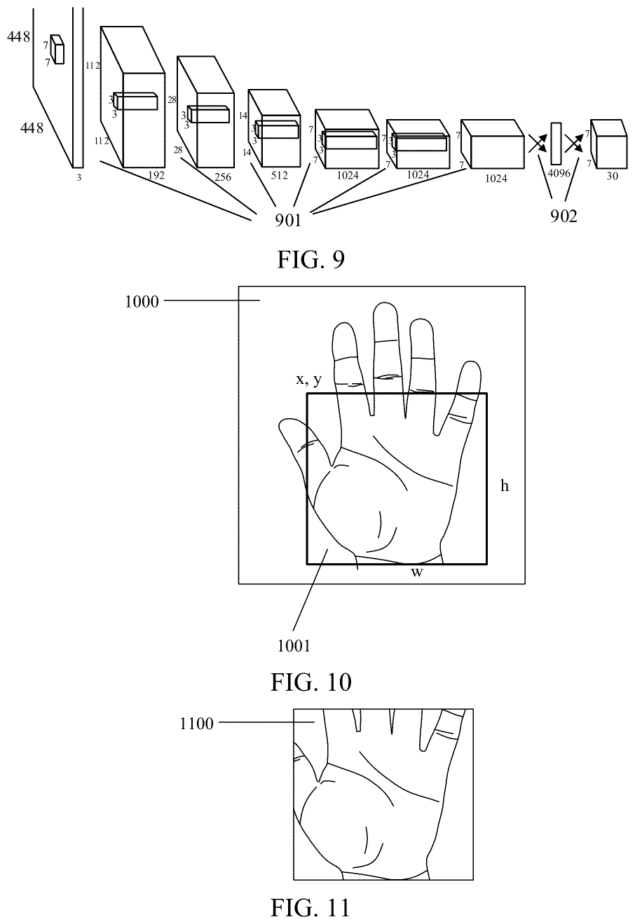

For example, referring to FIG. 9, FIG. 9 is a schematic structural diagram of a YOLO model according to an embodiment of the present disclosure. As shown in FIG. 9, the YOLO model provided in the embodiments of the present disclosure may include a plurality of convolutional layers 901 (for example, six convolutional layers) and a plurality of fully connected layers 902 (for example, two fully connected layers). The convolutional layers 901 are mainly configured to extract features, and the fully connected layers 902 are mainly configured to predict class probabilities and coordinates. Finally, an output of the YOLO model is a 7*7*30 tensor, where 7*7 is a quantity of grid cells.

In some embodiments, as shown in FIG. 10, after calling the foregoing YOLO model to perform detection on the image 1000, the palm-scan terminal may obtain a position of a palm box 1001 of the palm in the image 1000. x and y are a pixel position in an upper left corner of the palm box 1001. W and h represent a width and a height of the palm box 1001, respectively.

### 2. Palm Key Point Detection

In some embodiments, as shown in FIG. 11, after performing detection on the image through the YOLO model, the palm-scan terminal may obtain a region image 1100 of a region in which the palm of the user is located. This can effectively avoid interference caused by irrelevant content.

However, in a process of approaching the palm-scan terminal by the palm of the user, due to angular image distortion or other factors, sizes of palm boxes at different distances may be inaccurate. Based on this, in this embodiment of the present disclosure, alternatively, a key point detection model (for example, a palm key point detection algorithm) may be called to obtain several accurate palm key point positions that are relatively fixed in the palm, thereby avoiding a problem of inaccurate sizes of the palm boxes caused by posture interference.

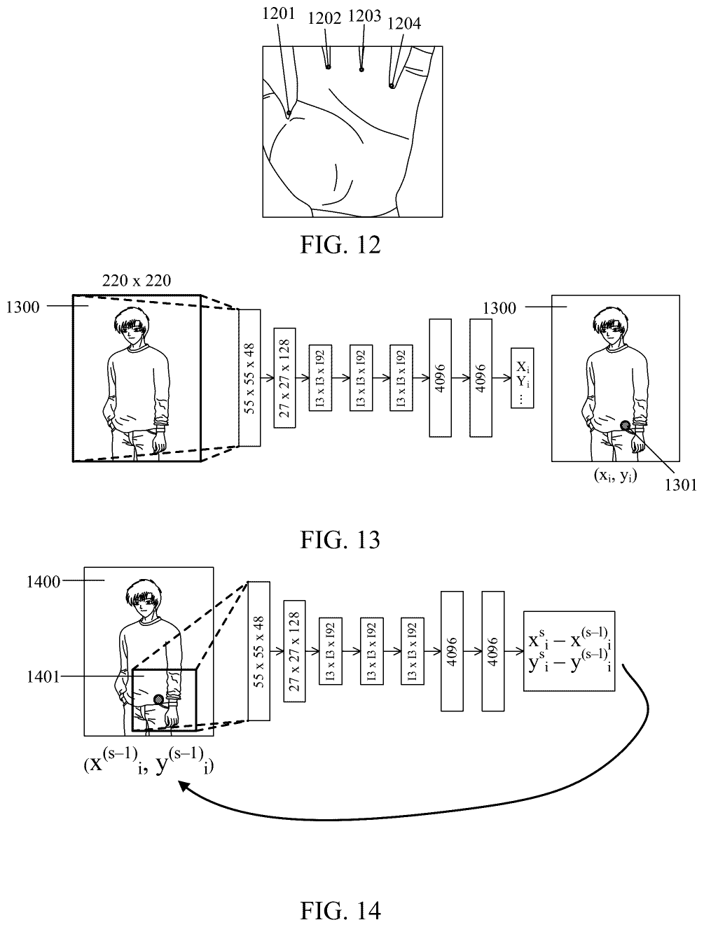

For example, referring to FIG. 12, FIG. 12 is a schematic diagram of palm key points according to an embodiment of the present disclosure. As shown in FIG. 12, after calling a key point detection model to perform key point detection on the region image of the region in which the palm is located shown in FIG. 11, the palm-scan terminal may obtain a plurality of palm key points included in the palm of the user, including, for example, a palm key point 1201, a palm key point 1202, a palm key point 1203, and a palm key point 1204.

The key point detection model provided in the embodiments of the present disclosure is described below.

In some embodiments, prediction of a palm key point may be performed through a DeepPose model. A main idea of the DeepPose model is as follows: The problem of ergonomics in complex poses is no longer considered. Instead, the key point detection algorithm is changed into a pure learning prediction problem. A more general end-to-end key point detection algorithm is implemented by manually annotating a large amount of human key point data in various poses and learning the sample data through deep neural networks (DNNs).

For example, referring to FIG. 13, FIG. 13 is a schematic structural diagram of a key point detection model according to an embodiment of the present disclosure. As shown in FIG. 13, after a series of convolution processing is performed on an inputted image 1300 with a size of 220*220, coordinates (Xᵢ, yᵢ) of a final object position 1301 may be further obtained through two fully connected layers.

In addition, since the size of the inputted object is not fixed, and the key point detection model accepts only input of an image with a size of 220*220, an error may exist in the prediction of the final object position due to zooming of an excessively large image. In view of this, as shown in FIG. 14, an image 1400 may be cropped to obtain a region around an estimated point position, an image region 1401 obtained through cropping is zoomed in, and then more accurate prediction is further performed, thereby improving final prediction accuracy.

The prediction of key points for the palm may be simplified into a regression problem. Details are not described herein again in this embodiment of the present disclosure. The core idea is to achieve end-to-end returning of a network prediction result based on the fitting of the DNNs to the non-linear regression problem.

### 3. Calculation of a Palm Movement Speed

In some embodiments, the payment intention of the user may be determined according to a movement speed of the palm in the XY plane within a period of time. For example, when the palm-scan terminal determines that the movement speed of the palm of the user is less than a set speed threshold, the payment is confirmed. Otherwise, the payment is canceled. For example, in the payment process, assuming that within a set duration (for example, 3 seconds, that is, 75 frames), the movement speed of the palm of the user in the XY plane (that is, a horizontal plane) is less than the speed threshold (assuming that it is denoted as a), the palm-scan terminal may confirm the payment.

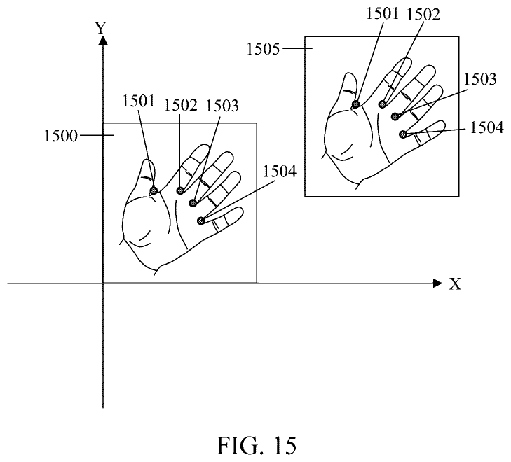

For example, referring to FIG. 15, FIG. 15 is a schematic diagram of a principle of calculating a movement speed of a palm key point according to an embodiment of the present disclosure. As shown in FIG. 15, a movement speed of a palm may be estimated by using the movement speed of the palm key point. For example, palm photographs captured by the palm-scan terminal every 5 frames (that is, 200 milliseconds) within 0 to 3 seconds may be used, to calculate a movement speed of the palm in each 5 frames. For example, a palm key point 1501 shown in FIG. 15 is used as an example. In the XY plane, it is assumed that coordinates of the palm key point 1501 in a palm photograph 1500 acquired at 0 seconds are (X1, Y1), and coordinates of the palm key point 1501 in a palm photograph 1505 acquired at 200 milliseconds are (X2, Y2). In this case, a movement speed V_{A} of the palm key point 1501 from 0 seconds to 200 milliseconds is:

$${V}_{A} = \frac{Δ H}{Δ t} = \frac{\sqrt{{( X 1 - X 2 )}^{2} + {( Y 1 - Y 2 )}^{2}}}{200} \qquad ( 3 )$$

where ΔH represents a distance between the coordinates (X1, Y1) of the palm key point 1501 in the palm photograph 1500 and the coordinates (X2, Y2) in the palm photograph 1505, and Δt represents a time difference (that is, 200 milliseconds) between an acquisition time of the palm photograph 1505 and an acquisition time of the palm photograph 1500.

Similarly, movement speeds of a palm key point 1502, a palm key point 1503, and a palm key point 1504 shown in FIG. 15 from 0 seconds to 200 milliseconds, respectively may be further calculated, and are assumed to be V_{B}, V_{C}, and V_{D}, respectively. Subsequently, an average value of the movement speeds of the four palm key points may be calculated, as the movement speed of the palm from 0 to 200 milliseconds. In other words, the movement speed V₁ of the palm from 0 to 200 milliseconds is:

$${V}_{1} = \frac{{V}_{A} + {V}_{B} + {V}_{C} + {V}_{D}}{4} \qquad ( 4 )$$

Then, the movement speed V₁ of the palm may be compared with the set speed threshold α. When V₁ is less than or equal to α, the palm-scan terminal may confirm the payment. Otherwise, it represents that the user has the palm simply skimming over the palm-scan device, that is, the palm-scan device cancels the payment.

By analogy, the palm-scan device may further calculate movement speeds corresponding to each 5 frames from 0 to 3 seconds, and it is assumed that the movement speeds are respectively V₁, V₂, V₃, V₄, . . . . To avoid incorrect deduction, the palm-scan device may confirm the payment only when all the above movement speeds are less than the set speed threshold α. Otherwise, the palm-scan device may cancel the payment.

The foregoing five frames is not fixed, and a frame interval may be flexibly adjusted based on an actual situation, or a fixed time interval may be used. This is not specifically limited in the embodiments of the present disclosure.

In some other embodiments, in addition to determining the movement of the palm based on the movement speed of the palm key point in the XY plane (that is, the horizontal plane), it may also be determined whether the palm is approaching or has a definite pause by determining a speed in a Z direction (that is, a vertical direction), thereby determining the payment intention of the user.

According to the biometric payment processing method provided in this embodiment of the present disclosure, in a process in which a user reaches for palm-scan payment, a movement speed of a palm key point in an XY plane is estimated through detection of the palm key point, and a palm movement pause point is determined by determining a speed change curve, to confirm a payment intention of the user. That is, it is ensured that payment is confirmed only when the palm of the user shows a relatively definite and conscious stay during the payment process of the user, thereby avoiding incorrect deduction caused by casual skimming by the palm, thus improving a sense of security of the user for palm-scan payment.

The following continues to describe an exemplary structure in which an implementation of the biometric payment processing apparatus 555 provided in the embodiments of the present disclosure is a software module. In some embodiments, as shown in FIG. 2, the software module in the biometric payment processing apparatus 555 stored in the memory 550 may include: an obtaining module 5551, a detection module 5552, a determining module 5553, and a payment module 5554.

The obtaining module 5551 is configured to obtain image data, the image data comprising a plurality of images of an organism that are successively acquired. The detection module 5552 is configured to detect a target part in an image in the image data, the target part being a part to which a biometric payment function is bound in the organism. The determining module 5553 is configured to determine, in response to that the target part is detected from the plurality of images, a movement speed corresponding to the target part in the plurality of images. The payment module 5554 is configured to perform a payment operation based on the target part in response to that the movement speed is less than a speed threshold.

In some embodiments, the detection module 5552 is further configured to perform key point detection processing on the target part to obtain a plurality of key points included in the target part. The determining module 5553 is further configured to determine a movement speed corresponding to each key point in the plurality of images; and determine, based on movement speeds respectively corresponding to the plurality of key points, the movement speed corresponding to the target part in the plurality of images.

In some embodiments, the determining module 5553 is further configured to perform the following processing for the each key point: selecting a first image and a second image from the plurality of images, and determining a time difference between an acquisition time of the first image and an acquisition time of the second image; determining a distance between first coordinates and second coordinates, the first coordinates being coordinates of the key point in the first image, and the second coordinates being coordinates of the key point in the second image; and determining a result of dividing the distance by the time difference as the movement speed corresponding to the key point in the plurality of images.

In some embodiments, the determining module 5553 is further configured to select a first image and a second image each with a quality parameter greater than a quality parameter threshold from the plurality of images, a time difference between an acquisition time of the first image and an acquisition time of the second image being greater than a time difference threshold.

In some embodiments, the determining module 5553 is further configured to determine an average movement speed of the plurality of movement speeds in a one-to-one correspondence with the plurality of key points; and determine the average movement speed as the movement speed corresponding to the target part in the plurality of images.

In some embodiments, the detection module 5552 is further configured to call a key point detection model to perform key point detection processing on the target part to obtain the plurality of key points included in the target part, the key point detection model being obtained through training based on a sample part of a sample organism and key points annotated for the sample part.

In some embodiments, the biometric payment processing apparatus 555 further includes a cropping module 5555 and a zoom-in module 5556. The cropping module 5555 is configured to crop the image to obtain a region image of a region in which the target part is located before the detection module 5552 calls the key point detection model to perform key point detection processing on the target part. The zoom-in module 5556 is configured to zoom in the region image. The detection module 5552 is further configured to call the key point detection model to perform key point detection processing on the zoomed-in region image.

In some embodiments, the key point detection model includes a plurality of cascaded convolutional layers and a plurality of cascaded fully connected layers. The detection module 5552 is further configured to perform convolution processing on feature information corresponding to the target part through the first convolutional layer in the plurality of cascaded convolutional layers; input a convolution result outputted by the first convolutional layer to a subsequent cascaded convolutional layer, and continue to perform convolution processing through the subsequent cascaded convolutional layer until the last convolutional layer; perform, through the first fully connected layer in the plurality of cascaded fully connected layers, fully connected processing on a convolution result outputted by the last convolutional layer; input a fully connected result outputted by the first fully connected layer to a subsequent cascaded fully connected layer, and continue to perform fully connected processing through the subsequent cascaded fully connected layer until the last fully connected layer; and determine a plurality of points respectively corresponding to a plurality of coordinates outputted by the last fully connected layer in the image as the plurality of key points included in the target part.

In some embodiments, the biometric payment processing apparatus 555 further includes a division module 5557, configured to divide the plurality of images into a plurality of image groups according to a set frame interval. The determining module 5553 is further configured to determine a movement speed corresponding to the target part in each image group. The payment module 5554 is further configured to perform the payment operation based on the target part in response to that a plurality of movement speeds respectively corresponding to the target part in the plurality of image groups are all less than the speed threshold.

In some embodiments, the payment module 5554 is further configured to cancel the payment operation based on the target part in response to that the movement speed of the target part in any one of the image groups is greater than the speed threshold.

In some embodiments, the detection module 5552 is further configured to call an object detection model to detect the target part in the image in the image data, the object detection model is obtained through training based on a sample image and a sample part annotated for the sample image.

In some embodiments, the detection module 5552 is further configured to: for the image in the image data, call the object detection model to perform the following processing: determining a plurality of bounding boxes in the image and a confidence score corresponding to each bounding box, the confidence score being configured for representing a probability that the bounding box includes the target part; classifying the each bounding box based on the confidence score according to whether the each bounding box includes the target part; and performing regression processing on a target bounding box determined to include the target part, to obtain a corrected position of the target bounding box.

In some embodiments, a type of the target part includes: a palm, a finger, a wrist, or a face.

The foregoing descriptions of the apparatus embodiment are similar to the foregoing descriptions of the method embodiment, and the apparatus embodiment has beneficial effects similar to those of the method embodiment, and therefore is not described in detail. Technical details not mentioned in the biometric payment processing apparatus provided in the embodiments of the present disclosure may be understood according to the descriptions of any one of FIG. 3 to FIG. 5.

An embodiment of the present disclosure provides a computer program product, the computer program product including a computer program or a computer-executable instruction, the computer program or the computer-executable instruction being stored in a computer-readable storage medium. A processor of a computer device reads the computer-executable instruction from the computer-readable storage medium, and the processor executes the computer-executable instruction, to cause the computer device to perform the biometric payment processing method according to the embodiments of the present disclosure.

An embodiment of the present disclosure provides a non-transitory computer-readable storage medium having a computer-executable instruction stored therein, the computer-executable instruction, when executed by a processor, causing the processor to perform the biometric payment processing method provided in the embodiments of the present disclosure, for example, the biometric payment processing method shown in any one of FIG. 3 to FIG. 5.

In some embodiments, the computer-readable storage medium may be a memory such as a FRAM, a ROM, a PROM, an EPROM, an EEPROM, a flash memory, a magnetic surface memory, a compact disc, or a CD-ROM; or may be various devices including one of or any combination of the foregoing memories.

In some embodiments, the executable instruction may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

In an example, the executable instruction may be deployed to be executed on one electronic device, or executed on a plurality of electronic devices located at one location, or executed on a plurality of electronic devices distributed at a plurality of locations and interconnected by a communication network.

The foregoing descriptions are merely embodiments of the present disclosure and are not intended to limit the protection scope of the present disclosure. Any modification, equivalent replacement, or improvement made without departing from the spirit and scope of the present disclosure shall fall within the protection scope of the present disclosure.

What is claimed is:

1. A biometric payment processing method, performed by an electronic device, the method comprising:
obtaining image data, the image data comprising a plurality of images of an organism that are successively acquired;
detecting a target part in an image in the image data, the target part being a part in the organism to which a biometric payment function is bound;
determining, in response to that the target part is detected from the plurality of images in the image data, a movement speed corresponding to the target part in the plurality of images; and
performing a payment operation based on the target part in response to the movement speed being less than a speed threshold.

2. The method according to claim 1, wherein the determining a movement speed corresponding to the target part in the plurality of images comprises:
performing key point detection processing on the target part to obtain a plurality of key points comprised in the target part;
determining a movement speed corresponding to each key point in the plurality of images; and
determining, based on movement speeds respectively corresponding to the plurality of key points, the movement speed corresponding to the target part in the plurality of images.

3. The method according to claim 2, wherein the determining a movement speed corresponding to each key point in the plurality of images comprises:
performing the following processing for the each key point:
selecting a first image and a second image from the plurality of images, and determining a time difference between an acquisition time of the first image and an acquisition time of the second image;
determining a distance between first coordinates and second coordinates, the first coordinates being coordinates of the key point in the first image, and the second coordinates being coordinates of the key point in the second image; and
determining a result of dividing the distance by the time difference as the movement speed corresponding to the key point in the plurality of images.

4. The method according to claim 3, wherein the selecting a first image and a second image from the plurality of images comprises:
selecting, from the plurality of images, the first image and the second image each with a quality parameter greater than a quality parameter threshold, the time difference between the acquisition time of the first image and the acquisition time of the second image being greater than a time difference threshold.

5. The method according to claim 2, wherein the determining, based on movement speeds respectively corresponding to the plurality of key points, the movement speed corresponding to the target part in the plurality of images comprises:
determining an average movement speed of the plurality of movement speeds in a one-to-one correspondence with the plurality of key points; and
determining the average movement speed as the movement speed corresponding to the target part in the plurality of images.

6. The method according to claim 2, wherein the performing key point detection processing on the target part to obtain a plurality of key points comprised in the target part comprises:
calling a key point detection model to detect the plurality of key points comprised in the target part, the key point detection model being obtained through training based on a sample part of a sample organism and key points annotated for the sample part.

7. The method according to claim 6, further comprising:
cropping the image to obtain a region image of a region in which the target part is located, and zooming in the region image; and
the calling a key point detection model comprises:
calling the key point detection model to perform key point detection processing on the zoomed-in region image.

8. The method according to claim 6, wherein
the key point detection model comprises a plurality of cascaded convolutional layers and a plurality of cascaded fully connected layers; and
the calling a key point detection model to detect the plurality of key points comprised in the target part comprises:
performing convolution processing on feature information corresponding to the target part through the first convolutional layer in the plurality of cascaded convolutional layers;
inputting a convolution result outputted by the first convolutional layer to a subsequent cascaded convolutional layer, and continuing to perform convolution processing through the subsequent cascaded convolutional layer until the last convolutional layer;
performing, through the first fully connected layer in the plurality of cascaded fully connected layers, fully connected processing on a convolution result outputted by the last convolutional layer;
inputting a fully connected result outputted by the first fully connected layer to a subsequent cascaded fully connected layer, and continuing to perform fully connected processing through the subsequent cascaded fully connected layer until a last fully connected layer; and
determining a plurality of points respectively corresponding to a plurality of coordinates outputted by the last fully connected layer in the image as the plurality of key points comprised in the target part.

9. The method according to claim 1, wherein the determining a movement speed corresponding to the target part in the plurality of images comprises:
dividing the plurality of images into a plurality of image groups according to a set frame interval; and
determining a movement speed corresponding to the target part in each image group; and
the performing a payment operation based on the target part in response to that the movement speed is less than a speed threshold comprises:
performing the payment operation based on the target part in response to that a plurality of movement speeds respectively corresponding to the target part in the plurality of image groups are less than the speed threshold.

10. The method according to claim 9, wherein the method further comprises:
canceling the payment operation based on the target part in response to that the movement speed of the target part in one of the image groups is greater than the speed threshold.

11. The method according to claim 1, wherein the detecting a target part in an image in the image data comprises:
calling an object detection model to detect the target part in the image in the image data, the object detection model being obtained through training based on a sample image and a sample part annotated for the sample image.

12. The method according to claim 11, wherein the calling an object detection model to detect the target part in the image in the image data comprises:
for the image in the image data, calling the object detection model to perform the following processing:
determining a plurality of bounding boxes in the image and a confidence score corresponding to each bounding box, the confidence score being configured for representing a probability that the bounding box comprises the target part;
classifying the each bounding box based on the confidence score according to whether the each bounding box comprises the target part; and
performing regression processing on a target bounding box determined to comprise the target part, to obtain a corrected position of the target bounding box.

13. The method according to claim 1, wherein a type of the target part comprises: a palm, a finger, a wrist, or a face.

14. A biometric payment processing apparatus, the apparatus comprising:
at least one memory, configured to store executable instructions; and
at least one processor, configured to execute the executable instructions stored in the at least one memory, to implement:
obtaining image data, the image data comprising a plurality of images of an organism that are successively acquired;
detecting a target part in an image in the image data, the target part being a part in the organism to which a biometric payment function is bound;
determining, in response to that the target part is detected from the plurality of images in the image data, a movement speed corresponding to the target part in the plurality of images; and
performing a payment operation based on the target part in response to the movement speed being less than a speed threshold.

15. The apparatus according to claim 14, wherein the determining a movement speed corresponding to the target part in the plurality of images comprises:
performing key point detection processing on the target part to obtain a plurality of key points comprised in the target part;
determining a movement speed corresponding to each key point in the plurality of images; and
determining, based on movement speeds respectively corresponding to the plurality of key points, the movement speed corresponding to the target part in the plurality of images.

16. The apparatus according to claim 15, wherein the determining a movement speed corresponding to each key point in the plurality of images comprises:
performing the following processing for the each key point:
selecting a first image and a second image from the plurality of images, and determining a time difference between an acquisition time of the first image and an acquisition time of the second image;
determining a distance between first coordinates and second coordinates, the first coordinates being coordinates of the key point in the first image, and the second coordinates being coordinates of the key point in the second image; and
determining a result of dividing the distance by the time difference as the movement speed corresponding to the key point in the plurality of images.

17. The apparatus according to claim 16, wherein the selecting a first image and a second image from the plurality of images comprises:
selecting, from the plurality of images, the first image and the second image each with a quality parameter greater than a quality parameter threshold, the time difference between the acquisition time of the first image and the acquisition time of the second image being greater than a time difference threshold.

18. The apparatus according to claim 15, wherein the determining, based on movement speeds respectively corresponding to the plurality of key points, the movement speed corresponding to the target part in the plurality of images comprises:
determining an average movement speed of the plurality of movement speeds in a one-to-one correspondence with the plurality of key points; and
determining the average movement speed as the movement speed corresponding to the target part in the plurality of images.

19. The apparatus according to claim 15, wherein the performing key point detection processing on the target part to obtain a plurality of key points comprised in the target part comprises:
calling a key point detection model to detect the plurality of key points comprised in the target part, the key point detection model being obtained through training based on a sample part of a sample organism and key points annotated for the sample part.

20. A non-transitory computer-readable storage medium, having a computer-executable instruction stored therein, the computer-executable instruction, when executed by at least one processor, causing the at least one processor to implement:
obtaining image data, the image data comprising a plurality of images of an organism that are successively acquired;
detecting a target part in an image in the image data, the target part being a part in the organism to which a biometric payment function is bound;
determining, in response to that the target part is detected from the plurality of images in the image data, a movement speed corresponding to the target part in the plurality of images; and
performing a payment operation based on the target part in response to the movement speed being less than a speed threshold.
